(19) United States
(12) Patent Application Publication
(10) Pub. No.: US 2006/0013306 A1
(43) Pub. Date: Jan. 19, 2006

(54) Motion information encoding/decoding apparatus and method and scalable video encoding/decoding apparatus and method employing them

(75) Inventors: Joohee Kim, Yongin-si (KR); Hyayun Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/181,805

(22) Filed: Jul. 15, 2005

Related U.S. Application Data
(60) Provisional application No. 60/587,878, filed on Jul. 15, 2004.

(51) Int. Cl. H04N 7/12; H04N 11/04; H04B 1/66; H04N 11/02

(52) U.S. Cl. 375/240.12; 375/240.24; 375/240.08

(57) ABSTRACT

Provided are motion information encoding/decoding apparatus and method and scalable video encoding/decoding apparatus and method employing the same. The motion information encoding apparatus includes a first motion estimation unit, a second motion estimation unit, and an encoding unit. The first motion estimation unit generates base motion data for a layer corresponding to a low bit rate among a plurality of layers by performing motion estimation in units of a first block and generates enhancement data for the layer corresponding to the low bit rate by performing motion estimation in units of a second block. The second motion estimation unit generates motion data for the layer having the higher bit rate by performing motion estimation. The encoding unit performs encoding on the base motion data and the enhancement motion data provided from the first motion estimation unit or the motion data provided from the second motion estimation unit.

### CROSS-REFERENCE TO RELATED PATENT APPLICATION

This application claims the benefit of U.S. Provisional Patent Application Ser. No. 60/587,878, filed on Jul. 15, 2004, in the U.S. Patent and Trademark Office, the disclosure of which is incorporated herein in its entirety by reference.

### BACKGROUND OF THE INVENTION

1. Field of the Invention

The present invention relates to scalable video encoding and decoding, and more particularly, to motion information encoding/decoding apparatus and method, in which subjective display quality of a reconstructed image can be greatly improved at a low bit rate, and scalable video encoding/decoding apparatus and method using the motion information encoding/decoding apparatus and method.

2. Description of the Related Art

It is well known that the coding efficiency of motion-compensated video coding is strongly dependent on the bit-allocation between motion data and residual data, i.e. texture data. The optimal trade-off is dependent on the spatial and temporal resolution as well as the bit-rate. With a single motion field, it is difficult to generate a scalable bitstream that provides a nearly rate-distortion-optimal coding efficiency over a large scale of spatio-temporal resolutions and bit-rates. Therefore, a scalable bitstream should contain a scalable representation of the motion data.

For an advance video coding (AVC)-based motion compensated temporal filtering (MCTF) approach, two different concepts have been used for providing signal-to-noise ratio (SNR) scalability and spatial scalability. For achieving SNR scalability, the low-pass and high-pass pictures obtained as a result of motion-compensated temporal filtering are coded using a layered representation. In each enhancement layer, approximations of the residual signals computed between the original subband pictures and the reconstructed subband pictures obtained after decoding the base layer and previous enhancement layers are transmitted. For all SNR layers of the same spatial resolution, the same motion field is used and the residual data are predicted from the previous SNR layer. However, for each spatial layer, a separate motion field is estimated and transmitted. In other words, the motion fields of different spatial layers are coded independently; and the residual data are transmitted without prediction from previous spatial layers. A prediction from the subordinate spatial layer is only exploited for the coding of intra macroblocks. As such, a prediction of motion and residual data could improve the coding efficiency of the AVC-based MCTF approach.

However, in at least one layer using a low bit rate in a scalable bitstream generated by the above-described approach, the amount of motion data is relatively large when compared to residual data, thus making display quality degradation severer.

### SUMMARY OF THE INVENTION

The present invention provides motion information encoding/decoding apparatus and method, in which subjective display quality of a reconstructed image can be greatly improved at a low bit rate.

The present invention also provides scalable video encoding/decoding apparatus and method employing the motion information encoding/decoding apparatus and method.

According to an aspect of the present invention, there is provided a motion information encoding apparatus comprising an encoding rule determining unit determining an encoding rule of a motion compensation mode of a second block according to motion compensation modes of a first block and the second block corresponding to the first block in base motion data and enhancement motion data of a first layer of a scalable bitstream generated by scalable video encoding; and a motion compensation mode encoding unit encoding the motion compensation mode of the second block for the enhancement motion data based on the determined encoding rule.

According to another aspect of the present invention, there is provided a motion information encoding apparatus comprising an encoding rule determining unit determining an encoding rule of a motion compensation mode of a second block according to motion compensation modes of a first block and the second block corresponding to the first block in motion data of a first layer and motion data of a second layer in a scalable bitstream generated by scalable video encoding; and a motion compensation mode encoding unit encoding the motion compensation mode of the second block for the motion data of the second layer based on the determined encoding rule.

According to still another aspect of the present invention, there is provided a motion information encoding method comprising determining an encoding rule of a motion compensation mode of a second block according to motion compensation modes of a first block and the second block corresponding to the first block in base motion data and enhancement motion data of a first layer of a scalable bitstream generated by scalable video encoding; and encoding the motion compensation mode of the second block for the enhancement motion data based on the determined encoding rule.

According to yet another aspect of the present invention, there is provided a motion information encoding method comprising determining an encoding rule of a motion compensation mode of a second block according to motion compensation modes of a first block and the second block corresponding to the first block in motion data of a first layer and motion data of a second layer in a scalable bitstream generated by scalable video encoding; and encoding the motion compensation mode of the second block for the motion data of the second layer based on the determined encoding rule.

According to yet another aspect of the present invention, there is provided a motion information decoding apparatus comprising an indicator analyzing unit analyzing an indicator included in a bitstream of a second layer and determining a decoding rule corresponding to an encoding rule corresponding to the analyzed indicator, the bitstream of the second layer and a bitstream of a first layer being separated from a scalable bitstream; and a motion compensation mode decoding unit decoding a motion compensation mode of the second layer based on the decoding rule determined by the indicator analyzing unit.

According to yet another aspect of the present invention, there is provided a motion information decoding apparatus comprising an indicator analyzing unit analyzing an indicator included in a bitstream of a second layer including enhancement motion data of a first layer and determining a decoding rule corresponding to an encoding rule corresponding to the analyzed indicator, a bitstream of the first layer with base motion data being separated from a scalable bitstream; and a motion compensation mode decoding unit decoding a motion compensation mode of the enhancement motion data based on the decoding rule determined by the indicator analyzing unit.

According to yet another aspect of the present invention, there is provided a motion information decoding method comprising separating a scalable bitstream into a bitstream for each layer by demultiplexing the scalable bitstream; decoding a separated bitstream for a first layer by primarily referring to base motion data and secondarily referring to base motion data and enhancement motion data; and decoding a separated bitstream for a second layer by referring to video decoded from the bitstream of the first layer and motion data.

According to yet another aspect of the present invention, there is provided a motion information decoding method comprising analyzing an indicator included in a bitstream of a second layer and determining a decoding rule corresponding to an encoding rule corresponding to the analyzed indicator, the bitstream of the second layer and a bitstream of a first layer being separated from a scalable bitstream; and decoding a motion compensation mode of the second layer based on the determined decoding rule.

According to yet another aspect of the present invention, there is provided a scalable video encoding apparatus comprising a scalable encoding unit generating scalable motion data including base motion data and enhancement motion data as motion data of a first layer and generating a plurality of bitstreams including motion data and texture data for each layer by distributing the enhancement motion data over a second layer; and a multiplexing unit multiplexing the plurality of bitstreams and outputting a scalable bitstream.

According to yet another aspect of the present invention, there is provided a scalable video encoding method comprising generating scalable motion data including base motion data and enhancement motion data as motion data of a first layer and generating a plurality of bitstreams including motion data and texture data for each layer by distributing the enhancement motion data over a second layer; and multiplexing the plurality of bitstreams and outputting a scalable bitstream.

According to yet another aspect of the present invention, there is provided a scalable video decoding apparatus comprising a demultiplexing unit separating a scalable bitstream into a bitstream for each layer by demultiplexing the scalable bitstream; a first layer decoding unit decoding a separated bitstream for a first layer by primarily referring to base motion data and secondarily referring to base motion data and enhancement motion data; and a second layer decoding unit decoding a separated bitstream for a second layer by referring to video decoded by the first layer decoding unit and motion data.

According to yet another aspect of the present invention, there is provided a scalable video decoding method comprising separating a scalable bitstream into a bitstream for each layer by demultiplexing the scalable bitstream; decoding a separated bitstream for a first layer by primarily referring to base motion data and secondarily referring to base motion data and enhancement motion data; and decoding a separated bitstream for a second layer by referring to video decoded from the bitstream of the first layer and motion data.

The motion information encoding/decoding method and the scalable video encoding/decoding method may be implemented by a computer-readable recording medium having recorded thereon a program for implementing them. In addition, a scalable bitstream generated by the motion information encoding method or the scalable video encoding method may be recorded on or stored in a computer-readable recording medium.

### BRIEF DESCRIPTION OF THE DRAWINGS

The above and other features and advantages of the present invention will become more apparent by describing in detail an exemplary embodiment thereof with reference to the attached drawings in which:

FIG. 1 is a block diagram of a scalable video encoding apparatus according to an embodiment of the present invention;

FIGS. 2A and 2B are views for explaining a process of generating an exemplary scalable bitstream from a scalable video encoding apparatus shown in FIG. 1A;

FIG. 3 is a block diagram of a motion information encoding apparatus according to an embodiment of the present invention;

FIG. 4 is another exemplary scalable bitstream to which a motion information encoding method according to the present invention may be applied;

FIG. 5 is a detailed block diagram of an encoding unit showin in FIG. 3;

FIGS. 6A through 6E show motion estimation directions used to generate motion data;

FIGS. 7A through 7D show partition modes of a first block used for the base motion data generating unit of FIG. 3 to generate the base motion data;

FIGS. 8A through 8D show partition modes of a second block used for an enhancement motion data generating unit of FIG. 3 to generate enhancement motion data;

FIGS. 9A through 9C show a new motion compensation mode added when an encoding unit of FIG. 3 encodes the enhancement motion data;

FIG. 10 is a block diagram of a scalable video decoding apparatus according to an embodiment of the present invention;

FIG. 11 is a block diagram of a motion information decoding apparatus using according to an embodiment of the present invention;

FIGS. 12A and 12B are views for comparing encoded states of motion information in each layer of a scalable bitstream according to a prior art and a scalable bitstream according to the present invention when temporal scalability is provided to each layer;

FIGS. 13A and 13B are views for comparing subjective display qualities of images reconstructed by a conventional scalable encoding algorithm and the scalable encoding algorithm according to the present invention, in which reconstructed 24^{th} frames at 96 Kbps for a BUS sequence are compared;

FIGS. 14A and 14B are views for comparing subjective display qualities of images reconstructed by a conventional scalable encoding algorithm and the scalable encoding algorithm according to the present invention, in which reconstructed 258^{th} frames at 192 Kbps for a FOOTBALL sequence are compared; and

FIGS. 15A and 15B are views for comparing subjective display qualities of images reconstructed by a conventional scalable encoding algorithm and the scalable encoding algorithm according to the present invention, in which reconstructed 92^{nd} frames at 32 Kbps for a FOREMAN sequence are compared.

### DETAILED DESCRIPTION OF THE INVENTION

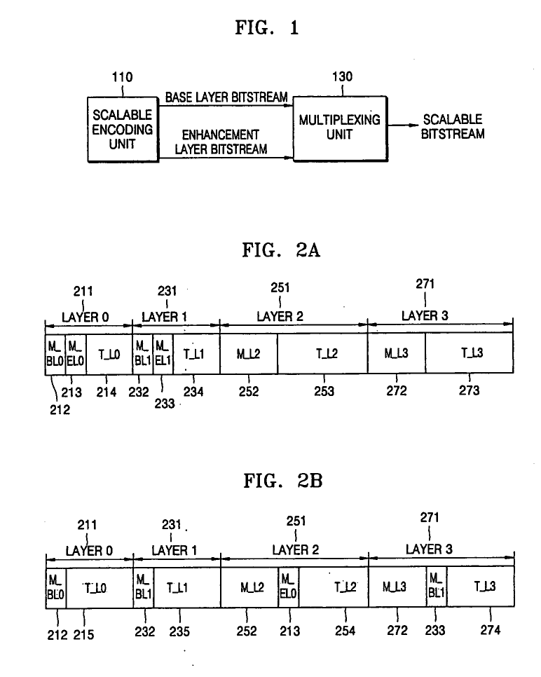

FIG. 1 is a block diagram of a scalable video encoding apparatus according to an embodiment of the present invention. The scalable video encoding apparatus includes a scalable encoding unit 110 and a multiplexing unit 130.

Referring to FIG. 1, the scalable encoding unit 110 generates a scalable bitstream containing bitstreams of a plurality of layers, the bitstream of each layer having motion data and texture data, based on a predetermined scalable encoding method.

In a first embodiment, the scalable encoding unit 110 configures the motion data of a layer using a low bit rate with base motion data and enhancement motion data, as shown in FIG. 2A, and assigns bits whose number is increased by bits assigned to the enhancement motion data to texture data of the layer using the low bit rate, compared to predetermined bits for the texture data. The scalable encoding unit 110 assigns bits whose number is reduced by bits assigned to the enhancement motion data of the layer corresponding to the low bit rate to texture data of a layer using a higher bit rate than the low bit rate, compared to predetermined bits for the texture data. The scalable encoding unit 110 generates a base layer bitstream and at least one enhancement layer bitstream by performing encoding based on the assigned bits and outputs the generated bitstreams to the multiplexing unit 130. Among a plurality of the generated bitstreams, a bitstram of a layer using a low bitrate comprises the base motion data and texture data, and a bitstram of a layer using a higher bitrate than the low bitrate comprises motion data, the enhancement motion data of the layer using the low bitrate and texture data, as shown in FIG. 2B. The used bit rate gradually increases from the base layer bitstream. Accordingly, the base layer bitstream is transmitted at the lowest bit rate. Here, the base layer bitstream may be decoded independently from other bitstreams and the enhancement layer bitstream is used to improve the base layer bitstream. At least one enhancement layer bitstream may be generated according to a bitstream scalability level.

In a second embodiment, the scalable encoding unit 110 configures the motion data of a layer using a low bit rate with base motion data and enhancement motion data, similar to the second embodiment. Further, with regard to corresponding blocks between the base motion data and the enhancement motion data, a motion compensation mode for the enhancement motion data is encoded depending on a motion compensation mode for the base motion data and motion compensation modes for the enhancement motion data. As a result, bits used to encode the motion compensation mode for the enhancement motion data may be largely decreased. Then, similar to the second embodiment, a bitstram of a layer using a low bitrate comprises the base motion data and texture data, and a bitstram of a layer using a higher bitrate than the low bitrate comprises motion data, the enhancement motion data of the layer using the low bitrate and texture data.

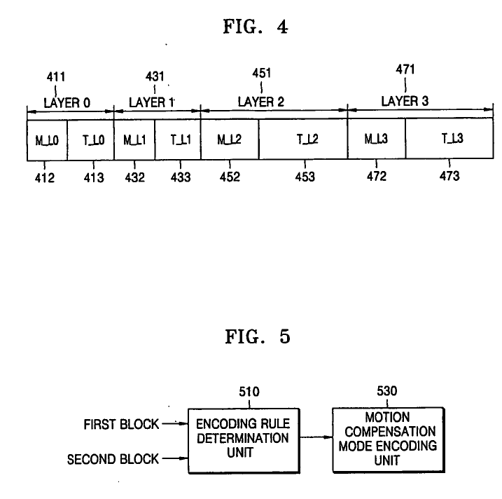

In a third embodiment, the scalable encoding unit 110 generates bitsteams for a plurality of layers, the bitstream for each layer having a single motion field and a texture filed, as shown in FIG. 4. Further, with regard to corresponding blocks between a first layer and a second layer, a motion compensation mode for the corresponding block of the second layer is encoded depending on a motion compensation mode for the corresponding block of the first layer and motion compensation modes for the corresponding block of the second layer. As a result, bits used to encode the motion compensation mode for each block of the second layer may be largely decreased. Here, the first layer and the second layer are closely located each other, like a layer 0 and a layer 1, a layer 1 and a layer 2, or a layer 2 and a layer 3 in FIG. 4.

A spatial scalable encoding method, a temporal scalable encoding method, a Signal-to-Noise Ratio (SNR) scalable encoding method, or a Fine Granularity Scalability (FGS) encoding method has been well known as a scalable encoding method used in the scalable encoding unit 110. For example, in the spatial scalable encoding method, a base layer bitstream is a bitstream with low resolution or a small-sized bitstream, and an enhancement layer bitstream is used to increase the resolution or size of the base layer bitstream. When the spatial scalable encoding method is adopted by television (TV) broadcast, the base layer bitstream is generated such that it can be reproduced by both the existing TV receiver and a high-definition TV receiver, and the enhancement layer bitstream is generated so that it can be reproduced only by the HDTV receiver. It is possible to make a bitstream that is compatible with both the existing TV receiver and the HDTV receiver by multiplexing these bitstreams.

The temporal scalable encoding method allows temporal resolution of a bitstream to be selectively improved. For instance, when a base-layer bitstream has a resolution with 30 frames per second, it is possible to increase the resolution of the base layer bitstream to a resolution with 60 frames per second using an enhancement layer bitstream. The SNR scalable encoding method allows the quality of a reproduced image to be selectively improved. For instance, when base-layer bitstreams contain a bitstream that will be reproduced as a low-quality image, it is possible to obtain a high-quality image by decoding the base layer bitstreams and decoding an enhancement layer bitstream based on a result of decoding. The FGS scalability encoding method guarantees scalability with more layers. There is a case where a transmitting side transmits a base layer bitstream that contains information of an image with a base quality and a minimum bandwidth permitted under a transmission environment, and an enhancement layer bitstream that contains information of an improved image with a maximum bandwidth, under a rapidly changing transmission environment, and a receiving side receives the base layer bitstream but does not receive the enhancement layer bitstream. In this case, the FGS scalability encoding method allows the information of the improved image to be reconstructed using all bitstreams received by the receiving side.

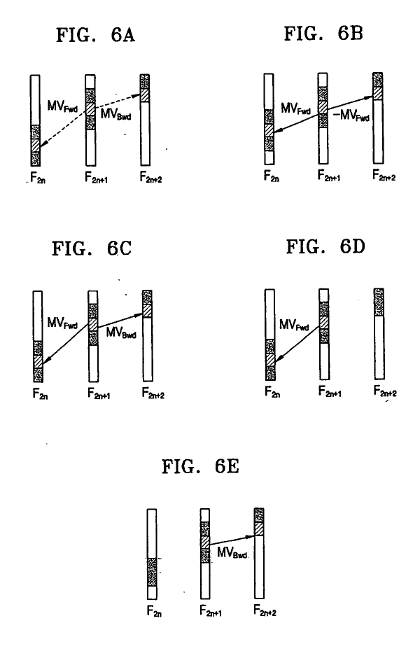

The multiplexing unit 130 multiplexes the base layer bitstream and at least one enhancement layer bitstream, provided from the scalable encoding unit 110, and outputs a scalable bitstream as shown in FIG. 2B or FIG. 6. Here, the multiplexing unit 130 may further include a recording medium such as a memory for temporarily storing or recording the generated scalable bitstream before outputting the same to a scalable video decoding apparatus.

FIGS. 2A and 2B are views for explaining a process of generating an exemplary scalable bitstream from a scalable video encoding apparatus shown in FIG. 1A. Here, the scalable bitstream is composed of four layers according to the temporal scalable encoding method and a motion field of a layer using a low bit rate has a scalability level of 1. However, the motion field of the layer corresponding to the low bit rate may also have a scalability level of 2 or higher. 7.5 quarter common intermediate format (QCIF) frames are provided per second in a layer 0 211, 15 QCIF frames per second in a layer 1 231, 30 common intermediate format (CIF) frames per second in a layer 2 251, and 60 4 CIF frames per second in a layer 3 271. Here, the layer 0 211 corresponds to a base layer bitstream and the layers 1 231 through 3 271 correspond to enhancement layer bitstreams. The layer 0 211 may be transmitted at a bit rate of 96 Kbps, the layer 1 231 at a bit rate of 192 Kbps, the layer 2 251 at a bit rate of 384 Kbps, and the layer 3 211 at a bit rate of 750 Kbps.

An exemplary scalable bitstream according to the present invention is designed such that layers using low bit rates, i.e., the layer 0 211 and the layer 1 231 herein have motion fields having scalability. Such a structure will be described in more detail with reference to the scalable video encoding apparatus shown in FIG. 1.

Referring to FIG. 2A, for the layer 0 211, the scalable encoding unit 110 generates base motion data and enhancement motion data, configures a first base motion field M_BL0 212 with the generated base motion data and a first enhancement motion field M_EL0 213 with the generated enhancement motion data, generates texture data, and configures a first texture field T_LO 214 with the generated texture data. Similarly, for the layer 1 231, the scalable encoding unit 110 generates base motion data and enhancement motion data, configures a second base motion field M_BL1 232 with the generated base motion data and a second enhancement motion field M_EL1 233 with the generated enhancement motion data, generates texture data, and configures a second texture field T_L1 234 with the generated texture data. For the layer 2 251, the scalable encoding unit 110 generates motion data, configures a first motion field M_L2 252 with the generated motion data, generates texture data, and configures a third texture field T_L2 253. For the layer 3 271, the scalable encoding unit 110 generates motion data, configures a second motion field M_L3 272 with the generated motion data, generates texture data, and configures a fourth texture field T_L3 273 with the generated texture data.

The scalable encoding unit 110 distributes the first enhancement motion field M_EL0 213 of the layer 0 211 and the second enhancement motion field M_EL1 233 of the layer 1 231 over the third texture field T_L2 253 of the layer 2 251 and the fourth texture field T_L3 273 of the layer 3 271, respectively, thereby generating a scalable bitstream as shown in FIG. 2B. The layer 0 211 is configured with the first base motion field M_BL0 212 and the first texture field T_L0 215, the layer 1 231 is configured with the second base motion field M_BL1 232 and the second texture field T_L1 235, the layer 2 251 is configured with the first motion field M_L2 252, the first enhancement motion field M_EL0 213, and the third texture field T_L2 254, and the layer 3 271 is configured with the second motion field M_L3 272, the second enhancement motion field M_EL1 233, and the fourth texture field T_L3 274. Since the number of bits assigned to each of the layers 0 211 through 3 271 is predetermined, in the layer 0 211, the same number of bits as that of bits assigned to the first enhancement motion field M_EL0 213 may be further assigned to the first texture field T_L0 215. For the same reason, in the layer 1 231, the same number of bits as that of bits assigned to the second enhancement motion field M_EL1 233 may be further assigned to the second texture field T_L1 235. Through such assignment, when an image is reconstructed using the layer 0 211 alone, or the layer 0 and the layer 1 231 corresponding to a low bit rate, display quality improvement can be achieved. In the layer 2 251 and the layer 3 271, the number of bits assigned to the third texture field T_L2 254 or the fourth texture field T_L3 274 may be reduced by that of bits assigned to the first enhancement motion field M_EL0 213 of the layer 0 211 or the second enhancement motion field M_EL1 233 of the layer 1 231. However, such assignment does not cause a change in display quality. When a motion field of a layer using a low bit rate has a scalability level of 2 or higher, it includes at least two enhancement motion fields, each of which may be sequentially distributed over layers using a higher bit rate than the low bit rate.

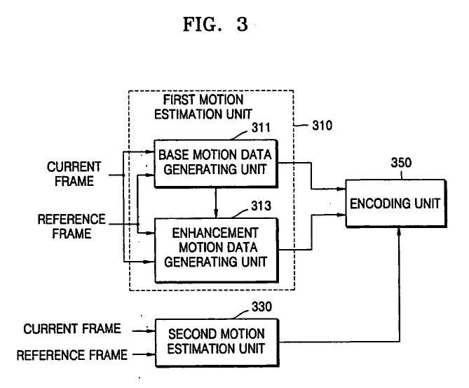

FIG. 3 is a block diagram of a motion information encoding apparatus according to an embodiment of the present invention. The motion information encoding apparatus of FIG. 3 is included in the scalable encoding unit 110 of FIG. 1. The scalable motion information encoding apparatus of FIG. 3 includes a first motion estimation unit 310, a second motion estimation unit 330, and an encoding unit 350. The first motion estimation unit 310 includes a base motion data generating unit 311 and an enhancement motion data generating unit 313. At least one enhancement motion data generating unit 310 may be included in the first motion estimation unit 310 according to a desired level of scalability in a motion field.

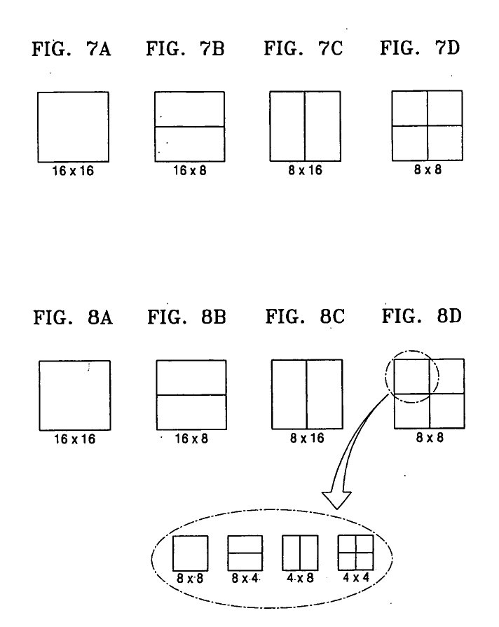

Referring to FIG. 3, the first motion estimation unit 310 generates base motion data and enhancement motion data constituting a motion field of at least one layer using a predetermined low bit rate. The base motion data generating unit 311 of the first motion estimation unit 310 performs motion estimation in units of a first partition constituting a first block using a current frame and at least one reference frame image such as at least one previous frame and/or at least one future frame and generates a motion vector for each first partition. The first block may have a size of 16×16. As shown in FIG. 7, the first block may have four partition modes in which the largest first partition has a size of 16×16 and the smallest first partition has a size of 8×8. The motion estimation direction and partition mode of the first block are decided to minimize the cost function C_{base}_{_{—}}_{^{MB}} defined below.

$${C}_{base\_MB} = {\sum }_{i ∈ I} [ {SAD}_{base} ( i , {MV}_{base}^{mode} ( i ) + {λ}_{base} R ( i , {MV}_{base}^{mode} ( i ) ) ] , \qquad ( 1 )$$

where I represents the number of partitions constituting the first block in each of the four partition modes. For example, in FIG. 7A, a single 16×16 partition constitutes the first block, and thus I is 1. In FIG. 7B, two 16×8 partitions constitute the first block, and thus I is 2. In FIG. 7C, two 8×16 partitions constitute the first block, and thus I is 2. In FIG. 7D, four 8×8 partitions constitute the first block, and thus I is 4. SAD_{base}(i,MV_{base}^{mode}(i)) represents a sum of absolute differences (SAD) when a motion estimation direction and a motion vector M_{base}^{mode}(i) are applied to each partition (i) in each partition mode. MV_{base}^{mode}(i) represents a motion estimation direction and a motion vector in each partition (i). λ_{base} represents a Lagrange multiplier, and R(i,MV_{base}^{mode}(i) represents the number of bits allocated to a motion estimation direction and the motion vector MV_{base}^{mode}(i) in each partition (i).

The base motion data generating unit 311 generates base motion data including a partition mode in units of the first block, and a motion estimation direction in units of each partition, i.e., indices of reference frames, and a motion vector in units of each partition, over a frame.

The enhancement motion data generating unit 313 generates a motion vector for each partition by performing motion estimation in units of a second partition constituting a second block having a location corresponding to the first block, using a current frame and at least one reference frames such as at least one previous frame and/or at least one future frame, in a partition mode of the first block decided using Equation 1. The second block has a size of 16×16. As shown in FIG. 6, the second block may have seven partition modes in which the largest second partition has a size of 16×16 and the smallest second partition has a size of 4×4. The motion estimation direction mode, i.e. motion compensation mode and partition mode of the second block are also decided to minimize a cost function defined in Equation 1. However, different Lagrange multipliers are used when the motion estimation direction and partition mode of the first block for the base motion data are decided and those of the second block for the enhancement motion data are decided. Thus, scalability of motion information can be obtained.

Similarly, the enhancement motion data generating unit 313 generates enhancement motion data including a partition mode in units of the second block, and a motion estimation direction in units of the second block or each partition, i.e., indices of reference frames, and a motion vector in units of each partition, over a frame.

The sizes of the first block and the second block are identical with each other, and the second block is more finely partitioned than the first block. Accordingly, the base motion data are obtained by a coarse motion estimation and the enhancement motion data are obtained by a fine motion estimation.

The second motion estimation unit 330 generates motion data constituting a bitstream of a layer corresponding to a higher bit rate than the low bit rate. The motion data is generated by general motion estimation using a current frame and at least one previous frame and/or at least one future frame. The motion data includes a partition mode in units of the second block, and a motion estimation direction in units of each partition, i.e., indices of reference frames, and a motion vector in units of each partition, over a frame.

The encoding unit 350 performs encoding on the motion data provided from the first motion estimation unit 310 or the second motion estimation unit 330. In particular, the encoding unit 350 sets three types of motion compensation modes between a first block and a second block corresponding to the first block, and sets an encoding rule according to the type of two motion compensation modes, in advance. The encoding unit 350 counts a type of motion compensation modes between the first block and the second block in the base motion data and the enhancement motion data provided from the first motion estimation unit 310 in units of frame, and encodes a motion compensation mode of the second blocks within one frame using an encoding rule of each type. According to the encoding result of one frame, the encoding unit 350 determines an encoding rule corresponding to a type having the smallest accumulated bits used to encode the motion compensation mode of the second blocks, so that bits necessary to encode the motion compensation mode of the second blocks can be reduced, as an encoding rule of the motion compensation mode of the second block in the frame. The encoding unit 350 performs variable-length coding of an indicator indicating the determined encoding rule, and performs variable-length coding of the motion compensation mode of the second block based on the determined encoding rule.

FIG. 4 is another exemplary scalable bitstream to which a motion information encoding method according to the present invention may be applied. In another exemplary scalable bitstream, each layer 411, 431, 451 or 471 has a single motion field 412, 432, 452 or 472 and a single texture field 413, 433, 453 or 473 regardless of its bit rate.

Referring to FIG. 4, the first block corresponds to motion data of a motion field 412 in a layer 0 411, e.g. and the second block corresponds to motion data of a motion field 432 in a layer 1 431. As such, an encoding principle of the encoding unit 350 may be applied to either motion data having scalability in a single layer as shown in FIG. 2A or motion data separately contained in two layers.

FIG. 5 is a detailed block diagram of an encoding unit 350 showin in FIG. 3. The encoding unit 350 comprises an encoding rule determination unit 510 and a motion compensation mode encoding unit 530.

Referring to FIG. 5, the encoding rule determination unit 510 counts a type of motion compensation modes between a corresponding first block and second block in the base motion data and the enhancement motion data provided from the first motion estimation unit 310 in units of frame, and encodes a motion compensation mode of the second blocks within one frame using an encoding rule of each type. According to the encoding result of one frame, the encoding rule determination unit 510 determines an encoding rule corresponding to a type having the largest difference between accumulated bits and original bits necessary to encode the motion compensation mode of the second blocks, as an encoding rule of the motion compensation mode of the second block in the frame.

The motion compensation mode encoding unit performs variable-length coding of an indicator indicating the determined encoding rule, and performs variable-length coding of the motion compensation mode of the second block based on the determined encoding rule.

FIGS. 6A through 6E show motion estimation directions, i.e., motion compensation modes, used for the base motion data generating unit 311 or the enhancement motion data generating unit 313 to generate the base motion data or enhancement motion data. FIG. 6A shows a first skip (SkiP) mode, FIG. 6B shows a direct (DirecT) mode, FIG. 6C shows a bidirectional (BiD) mode, FIG. 6D shows a forward (FwD) mode, and FIG. 6E shows a backward (BwD) mode.

FIG. 7A through 7D show four partition modes of the first block used for the base motion data generating unit 311 of FIG. 3 to generate the base motion data. FIG. 7A shows a partition mode in which a single 16×16 partition constitutes the first block, FIG. 7B shows a partition mode in which two 16×8 partitions constitute the first block, FIG. 7C shows a partition mode in which two 8×16 partitions constitute the first block, and FIG. 7D shows a partition mode in which four 8×8 partitions constitute the first block. In other words, the largest first partition constituting the first block has a size of 16×16 and the smallest first partition constituting the first block has a size of 8×8.

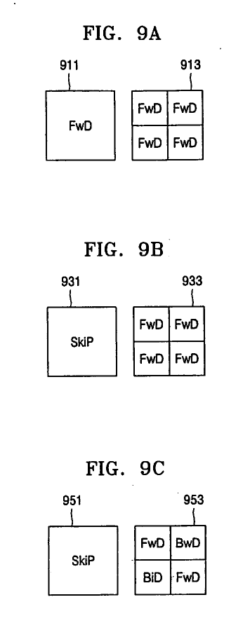

FIG. 8A through 8D show partition modes of the second block corresponding to the first block, used for the enhancement motion data generating unit 313 of FIG. 3 to generate the enhancement motion data. FIG. 8A shows a partition mode in which a single 16×16 partition constitutes the second block, FIG. 8B shows a partition mode in which two 8×16 partitions constitute the second block, FIG. 8C shows a partition mode in which two 16×8 partitions constitute the second block, FIG. 8D shows a partition mode in which four 8×8 partitions constitute the second block. Further, each of the 8×8 partitions in FIG. 8D is partitioned in two 4×8 partitions, two 8×4 partitions, or four 4×4 partitions. In other words, the largest second partition constituting the second block has a size of 16×16 and the smallest second partition constituting the second block has a size of 4×4.

FIGS. 9A through 9C show a new motion compensation mode, i.e., a second skip (New_SkiP) mode in units of the second block, added when the encoding unit 350 of FIG. 3 encodes the enhancement motion data. Here, a partition mode of the first block for the base motion data has the largest first partition size of 16×16 as in FIG. 7A and a partition mode of the second block for the enhancement motion data has the second partition size of 8×8 as in FIG. 8D. First, motion compensation modes included in the base motion data and the enhancement motion data of the entire frame are compared by referring to the first block and the second block, and an indicator (SkiP_indicator) indicating the type of a motion compensation mode of the second blocks within one frame is determined for each of layers corresponding to low bit rates or for two layers having a single motion field, respectively. The determined indicator is variable-length encoded and is recorded at the start of a motion field relevant to the second block in each frame. The indicator (SkiP_indicator) indicating the type of a motion compensation mode of the second block in the entire frame can be used for three different cases as shown in FIGS. 9A through 9C. In FIG. 9A, ‘SkiP_indicator’ is variable-length encoded to ‘0’. In FIG. 9B, ‘SkiP_indicator’ is variable-length encoded to ‘10’. In FIG. 9C, ‘SkiP_indicator’ is variable-length encoded to ‘11’.

More specifically, in FIG. 9A, motion compensation modes of four partitions of a second block 913 for the enhancement motion data are the same, a motion compensation mode of a first block 911 for the base motion data corresponding to the second block 913 is the same as the motion compensation modes of the four partitions of the second block 913, and ‘0’ is assigned as ‘SkiP_indicator’. In this case, for the enhancement motion data corresponding to the base motion data, only a variable-length code of a second skip (New_SkiP) mode is transmitted without performing variable-length encoding on the motion compensation modes of the four partitions of the second block 913 corresponding to the first block 911 in units of a second partition. In other words, when bits of a motion compensation mode of a second block due to motion compensation modes between a first block and a second block shown in FIG. 9A is actually reduced, ‘SkiP_indicator’ is ‘0’, a variable-length code of the second skip mode are transmitted as motion compensation modes of the second block 913 corresponding to the first block 911. Thus, the number of bits assigned to encode a motion compensation mode of the second block 913 is significantly reduced. Meanwhile, when a type of the motion compensation mode of the second block for one frame is determined as FIG. 9A, a type of the motion compensation modes between the first and second blocks is different from FIG. 9A, the motion compensation modes of all partitions of the second block are encoded.

In terms of decoding, motion data of a scalable bitstream is variable-length decoded and an indicator (SkiP_indicator) indicating the type of a motion compensation mode of the second block in one frame is checked for each of layers corresponding to low bit rates or for two layers having a single motion field, respectively. When ‘SkiP_indicator’ is ‘0’ and a second skip mode is received in units of a second block, a motion compensation mode corresponding to a variable-length code decoded for a first block is also applied to four partitions of a second block corresponding to the first block. That is, when ‘SkiP_indicator’ is ‘0’ and a second skip mode is received, the motion compensation mode of the second block is determined with reference to the motion compensation mode of the first block.

In FIG. 9B, motion compensation modes of four partitions of a second block 933 for enhancement motion data are the same, a motion compensation mode of a first block 931 for base motion data corresponding to the second block 933 is different from the motion compensation modes of the four partitions of the second block 933, and ‘10’ is assigned as ‘SkiP_indicator’. In this case, for the base motion data, the motion compensation mode of the first block 931 is variable-length encoded in units of a first partition. For the enhancement motion data corresponding to the base motion data, a variable-length code of a second skip mode and a variable length code of one motion compensation mode of the four partitions of the second block 933 are transmitted, without variable-length encoding the respective motion compensation modes of the four partitions 933 in units of a second partition. In other words, when bits of a motion compensation mode of a second block due to motion compensation modes between a first block and a second block shown in FIG. 9B is actually reduced, ‘SkiP_indicator’ is ‘10’, a variable-length code of the motion compensation mode of the first block 931, a variable-length code of the second skip mode, and a variable-length code of one motion compensation mode of the second block 933 are transmitted as motion compensation mode of the first block 931 and the second block 933 corresponding to the first block 931. Thus, the number of bits assigned to encode a motion compensation mode of the second block 933 is reduced. Meanwhile, when a type of the motion compensation mode of the second block for one frame is determined as FIG. 9B, a type of the motion compensation modes between the first and second blocks is different from FIG. 9A or FIG. 9B, the motion compensation modes of all partitions of the second block are encoded.

In terms of decoding, motion data of a scalable bitstream is variable-length decoded and an indicator (SkiP_indicator) indicating the type of a motion compensation mode of the entire frame is checked for each of layers corresponding to low bit rates, or for two layers having a single motion field, respectively. When ‘SkiP_indicator’ is ‘10’, a second skip mode is received in units of a second block, and a variable-length code of one motion compensation mode of the second block 933 is receved, the variable-length code of one motion compensation mode of the second block is applied to four partitions of a second block corresponding to the first block. That is, when ‘SkiP_indicator’ is ‘10’ and a second skip mode is received, the motion compensation modes of all partitions of the second block are determined using the transmitted motion compensation mode of the second block, without reference to the motion compensation mode of the first block.

In FIG. 9C, motion compensation modes of four partitions of a second block 953 for enhancement motion data are different from one another and ‘11’ is assigned as ‘SkiP_indicator’. In this case, for base motion data, a motion compensation mode of a first block 951 is variable-length encoded in units of a first partition. For enhancement motion data corresponding to the base motion data, the motion compensation modes of the four partitions of the second block 953 corresponding to the first block 951 are variable-length encoded in units of a second partition.

Table 1 shows motion compensation modes of a first block for base motion data and variable-length codes assigned to the motion compensation modes.

TABLE 1

| Variable-length code | Motion compensation mode |
|---|---|
| 0 | First skip (SkiP) |
| 10 | Direct (DirecT) |
| 110 | Bidirectional (BiD) |
| 1110 | Forward (FwD) |
| 1111 | Backward (BwD) |

Here, the first skip (SkiP) mode, the direct (DirecT) mode, the bidirectional (BiD) mode, the forward (FwD) mode, or the backward (BwD) mode is set in units of the first partition.

Table 2 shows motion compensation modes of a second block for enhancement motion data and variable-length codes assigned to the motion compensation modes. When compared to Table 1, a second skip mode is added to Table 2.

TABLE 2

| Variable-length code | Motion compensation mode |
|---|---|
| 0 | First skip (SkiP) |
| 10 | Second skip (New_SkiP) |
| 110 | Direct (DirecT) |
| 1110 | Bidirectional (BiD) |
| 11110 | Forward (FwD) |
| 111110 | Backward (BwD) |

Here, the first skip (SkiP) mode, the direct (DirecT) mode, the bidirectional (BiD) mode, the forward (FwD) mode, or the backward (BwD) mode is set in units of the second partition, and the second skip (New_SkiP) mode is set in units of the second block.

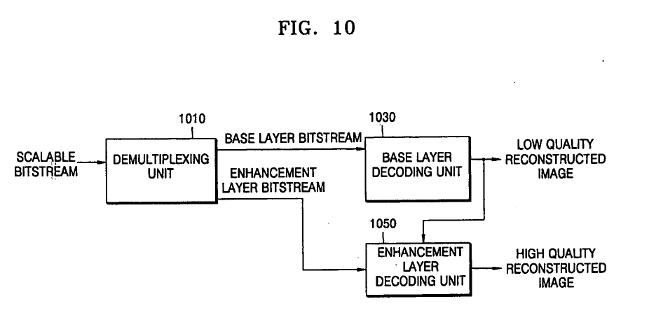

FIG. 10 is a block diagram of a scalable video decoding apparatus according to an embodiment of the present invention. The scalable video decoding apparatus includes a demultiplexing unit 1010, a base layer decoding unit 1030, and an enhancement layer decoding unit 1050. Here, at least one enhancement layer decoding unit 1050 may be included in the scalable video decoding apparatus according to a bitstream scalability level set in the scalable video encoding apparatus.

Referring to FIG. 10, the demultiplexing unit 1010 separates a bitstream for each layer from an input scalable bitstream and outputs a base layer bitstream and an enhancement layer bitstream. Here, the demultiplexing unit 1010 may further include a recording medium such as a memory for temporarily storing or recording a scalable bitstream provided from the scalable video encoding apparatus before decoding the same.

The base layer decoding unit 1030 decodes the separated base layer bitstream. An image decoded by the base layer decoding unit 1030 is a low low-quality of reconstructed image and can be displayed independently.

The enhancement-layer decoding unit 1050 decodes the separated enhancement layer bitstream by referring to an image decoded by the base layer decoding unit 1030. An image decoded by the enhancement layer decoding unit 1030 is a higher-quality of reconstructed image as the number of enhancement layers increases.

The base layer decoding unit 1030 and the enhancement-layer decoding unit 1050 perform decoding according to a decoding method corresponding to a scalable encoding method of the scalable encoding unit 110 of the scalable video encoding apparatus.

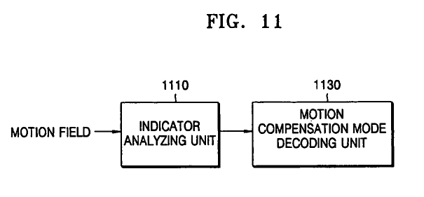

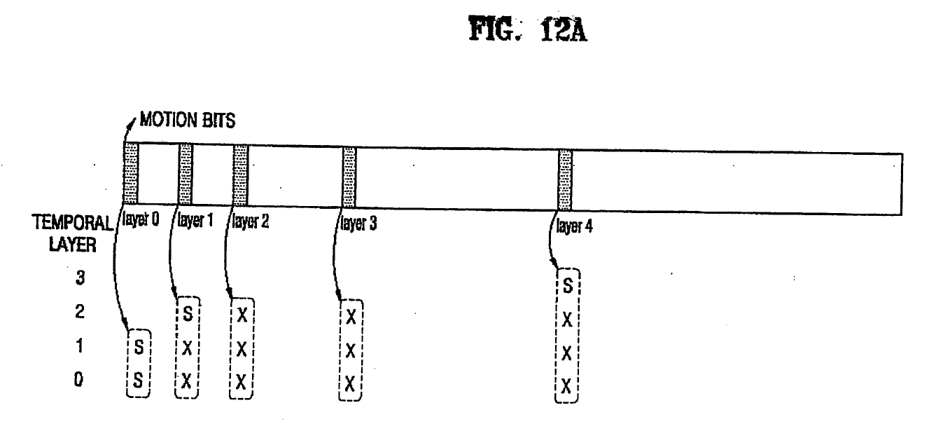

FIG. 11 is a block diagram of a motion information decoding apparatus using according to an embodiment of the present invention. The motion information decoding apparatus comprises an indicator analyzing unit 1110 and a motion compensation mode decoding unit 1130. In a case of a scalable bitstream shown in FIG. 2A, the motion information decoding apparatus may be included in the base layer decoding unit 1030. In a case of a scalable bitstream shown in FIG. 4, the motion information decoding apparatus may be included in the enhancement layer decoding unit 1050.

Referring to FIG. 11, the indicator analyzing unit 1110 analyzes an indicator contained in a start, e.g. a header of one frame in a bitstream separated from the demultiplexing unit 1010, and determines a decoding rule corresponding to an encoding rule according to the analyzed indicator. For example, when the indicator ‘Skip_indicator’ is ‘0’, a decoding rule corresponding to an encoding rule using only a second skip (New_SkiP) mode is applied to decoding of the motion compensation mode of the second block. When the indicator ‘Skip_indicator’ is ‘10’, a decoding rule corresponding to an encoding rule using a second skip (New_SkiP) mode and a motion compensation mode of the second block is applied to decoding of the motion compensation mode of the second block. When the indicator ‘Skip_indicator’ is ‘11’, a predetermined variable-length decoding rule is applied to decoding of the motion compensation mode of the second block, since the second skip (New_SkiP) mode is not used.

The motion compensation mode decoding unit 1130 decodes the motion compensation mode of the second block, based on the determined decoding rule by the indicator analyzing unit 1110.

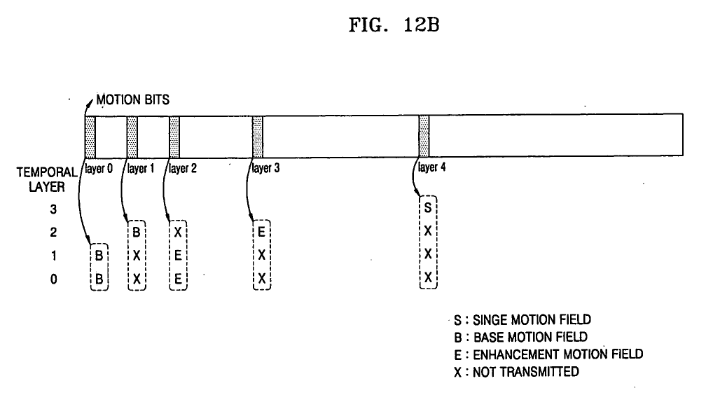

FIGS. 12A and 12B are views for comparing encoded states of motion information in each layer when temporal scalability is provided to each layer. FIG. 9A shows a scalable bitstream according to a conventional anchor and FIG. 9B shows a scalable bitstream according to the present invention.

Referring to FIG. 12A, a single motion field is used in each temporal layer. In other words, a single motion field S is transmitted to temporal layers 0 and 1 in a layer 0, a single motion field S is transmitted to a temporal layer 2 in a layer 1, a single motion field S is transmitted to a temporal layer 3 in a layer 4, and no motion field is transmitted to layers 2 and 3. Referring to FIG. 12B, a single motion field S is transmitted only to the highest temporal layer 4. Unlike FIG. 12A, a base motion field B is transmitted to temporal layers 0 and 1 in a layer 0, a base motion field B is transmitted to a temporal layer 2 in a layer 1, an enhancement motion field E distributed over the temporal layers 0 and 1 is transmitted to a layer 2, and an enhancement motion field E distributed over the layer 2 is transmitted to a layer 3.

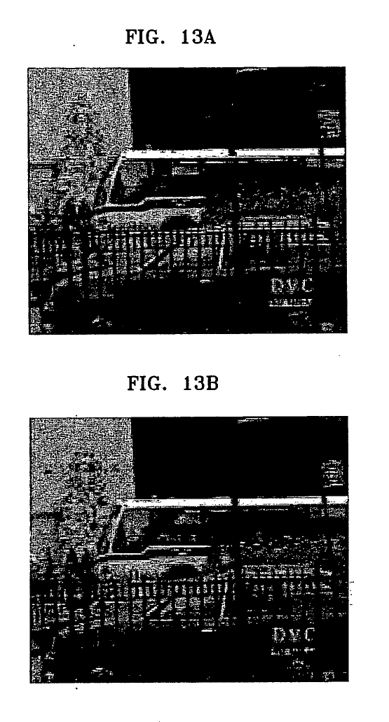

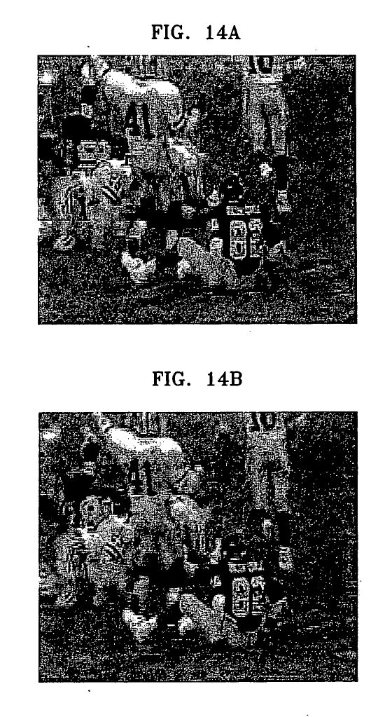

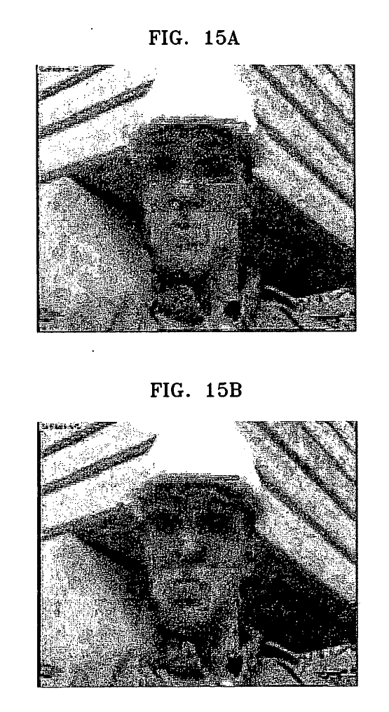

FIGS. 13A and 13B are views for comparing subjective display qualities of images reconstructed by the conventional anchor and a scalable encoding algorithm according to the present invention, in which reconstructed 24^{th} frames at 96 Kbps for a BUS sequence are compared. FIGS. 14A and 14B are views for comparing subjective display qualities of images reconstructed by the conventional anchor and a scalable encoding algorithm according to the present invention, in which reconstructed 258^{th} frames at 192 Kbps for a FOOTBALL sequence are compared. FIGS. 15A and 15B are views for comparing subjective display qualities of images reconstructed by the conventional anchor and a scalable encoding algorithm according to the present invention, in which reconstructed 92^{nd} frames at 3 Kbps for a FOREMAN sequence are compared. Thus, when compared to display qualities of reconstructed images according to the conventional anchor as shown in FIGS. 13A, 14A, and 15A, improvement of display qualities of reconstructed images according to the present invention as shown in FIGS. 13B, 14B, and 15B can be seen subjectively or visually.

As described above, according to the present invention, subjective, i.e., visual, display quality of a reconstructed image can be greatly improved at a low bit rate.

Preferably, the motion information encoding/decoding method and the scalable video encoding/decoding method can also be embodied as computer-readable code on a computer-readable recording medium having a program, code, or code segment recorded thereon for implementing them on a computer. Preferably, a bitstream generated by the motion information encoding method or the scalable video encoding method may be recorded on or stored in a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion. Also, functional programs, code, and code segments for implementing the scalable motion information encoding/decoding method and the scalable video encoding/decoding method can be easily construed by programmers skilled in the art.

While the present invention has been particularly shown and described with reference to an exemplary embodiment thereof, it will be understood by those of ordinary skill in the art that various changes in form and details may be made therein without departing from the spirit and scope of the present invention as defined by the following claims.

What is claimed is:

1. A scalable video encoding apparatus comprising:
a scalable encoding unit generating scalable motion data including base motion data and enhancement motion data as motion data of a first layer and generating a plurality of bitstreams including motion data and texture data for each layer by distributing the enhancement motion data over a second layer; and
a multiplexing unit multiplexing the plurality of bitstreams and outputting a scalable bitstream.

2. The scalable video encoding apparatus of claim 1, wherein the first layer uses a low bit rate and the second layer uses a higher bit rate than the low bit rate.

3. The scalable video encoding apparatus of claim 1, wherein the scalable encoding unit comprises:
a first motion estimation unit generating the base motion data for the first layer by performing motion estimation in units of a first block and generating the enhancement data for the first layer by performing motion estimation in units of a second block;
a second motion estimation unit generating the motion data for the second layer by performing motion estimation; and
an encoding unit encoding the base motion data and the enhancement motion data provided from the first motion estimation unit or the motion data provided from the second motion estimation unit.

4. The scalable video encoding apparatus of claim 3, wherein a partition of the second block is finer than that of the first block.

5. The scalable video encoding apparatus of claim 4, wherein the first block includes at least one of a 16×16 partition, a 16×8 partition, a 6×16 partition, and an 8×8 partition and the second block includes at least one of a 16×16 partition, a 16×8 partition, a 6×16 partition, an 8×8 partition, an 8×4 partition, a 4×8 partition, and a 4×4 partition.

6. The scalable video encoding apparatus of claim 3, wherein the encoding unit determines an encoding rule of a motion compensation mode of the second block according to motion compensation modes of the first block and the second block corresponding to the first block for the base motion data and the enhancement motion data of the first layer to reduce the number of bits required to encode a motion compensation mode of the enhancement motion data.

7. The scalable video encoding apparatus of claim 6, wherein the encoding unit determines the encoding rule of the motion compensation mode of the second block in frame units.

8. The scalable video encoding apparatus of claim 6, the encoding unit encodes an indicator indicating the determined encoding rule of the motion compensation mode of the second block and inserts the encoded indicator into each bitstream.

9. The scalable video encoding apparatus of claim 3, wherein the motion compensation mode of the second block includes at least one of a first skip mode, a direct mode, a bidirectional mode, a forward mode, and a backward mode, which are determined in partition units, and a second skip mode determined in units of the second block.

10. The scalable video encoding apparatus of claim 9, wherein the encoding unit encodes the motion compensation mode of the second block in the second skip mode when reducing the number of bits required to encode the motion compensation mode of the second block in a case where motion compensation modes of the first block and the second block are the same.

11. The scalable video encoding apparatus of claim 9, wherein the encoding unit encodes the motion compensation mode of the second block in the second skip mode and one motion compensation mode of the second block when reducing the number of bits required to encode the motion compensation mode of the second block in a case where motion compensation modes of all partitions included in the second block are the same and motion compensation modes of the first block and the second block are different.

12. A motion information encoding apparatus comprising:
an encoding rule determining unit determining an encoding rule of a motion compensation mode of a second block according to motion compensation modes of a first block and the second block corresponding to the first block in base motion data and enhancement motion data of a first layer of a scalable bitstream generated by scalable video encoding; and
a motion compensation mode encoding unit encoding the motion compensation mode of the second block for the enhancement motion data based on the determined encoding rule.

13. A motion information encoding apparatus comprising:
an encoding rule determining unit determining an encoding rule of a motion compensation mode of a second block according to motion compensation modes of a first block and the second block corresponding to the first block in motion data of a first layer and motion data of a second layer in a scalable bitstream generated by scalable video encoding; and
a motion compensation mode encoding unit encoding the motion compensation mode of the second block for the motion data of the second layer based on the determined encoding rule.

14. The motion information encoding apparatus of claim 13, wherein the encoding rule determining unit determines the encoding rule of the motion compensation mode of the second block according to the motion compensation modes of the first block and the second block corresponding the first block to reduce the number of bits required to encode a motion compensation mode of enhancement motion data.

15. The motion information encoding apparatus of claim 14, wherein a partition of the second block is finer than that of the first block.

16. The motion information encoding apparatus of claim 14, wherein the first block includes at least one of a 16×16 partition, a 16×8 partition, a 6×16 partition, and an 8×8 partition and the second block includes at least one of a 16×16 partition, a 16×8 partition, a 6×16 partition, an 8×8 partition, an 8×4 partition, a 4×8 partition, and a 4×4 partition.

17. The motion information encoding apparatus of claim 13, wherein the encoding rule determining unit determines the encoding rule of the motion compensation mode of the second block in frame units.

18. The motion information encoding apparatus of claim 13, wherein the encoding rule determining unit encodes an indicator indicating the determined encoding rule of the motion compensation mode of the second block and inserts the encoded indicator into each bitstream.

19. The motion information encoding apparatus of claim 13, wherein the motion compensation mode of the second block includes at least one of a first skip mode, a direct mode, a bidirectional mode, a forward mode, and a backward mode, which are determined in partition units, and a second skip mode determined in units of the second block.

20. The motion information encoding apparatus of claim 19, wherein the encoding rule determining unit encodes the motion compensation mode of the second block in the second skip mode that refers to a motion compensation mode of the first block when reducing the number of bits required to encode the motion compensation mode of the second block in a case where motion compensation modes of the first block and the second block are the same.

21. The motion information encoding apparatus of claim 19, wherein the encoding rule determining unit encodes the motion compensation mode of the second block in the second skip mode and one motion compensation mode of the second block when reducing the number of bits required to encode the motion compensation mode of the second block in a case where motion compensation modes of all partitions included in the second block are the same and motion compensation modes of the first block and the second block are different.

22. A scalable video encoding method comprising:
generating scalable motion data including base motion data and enhancement motion data as motion data of a first layer and generating a plurality of bitstreams including motion data and texture data for each layer by distributing the enhancement motion data over a second layer; and
multiplexing the plurality of bitstreams and outputting a scalable bitstream.

23. A motion information encoding method comprising:
determining an encoding rule of a motion compensation mode of a second block according to motion compensation modes of a first block and the second block corresponding to the first block in base motion data and enhancement motion data of a first layer of a scalable bitstream generated by scalable video encoding; and
encoding the motion compensation mode of the second block for the enhancement motion data based on the determined encoding rule.

24. A motion information encoding method comprising:
determining an encoding rule of a motion compensation mode of a second block according to motion compensation modes of a first block and the second block corresponding to the first block in motion data of a first layer and motion data of a second layer in a scalable bitstream generated by scalable video encoding; and
encoding the motion compensation mode of the second block for the motion data of the second layer based on the determined encoding rule.

25. A scalable video decoding apparatus comprising:
a demultiplexing unit separating a scalable bitstream into a bitstream for each layer by demultiplexing the scalable bitstream;
a first layer decoding unit decoding a separated bitstream for a first layer by primarily referring to base motion data and secondarily referring to base motion data and enhancement motion data;
a second layer decoding unit decoding a separated bitstream for a second layer by referring to video decoded by the first layer decoding unit and motion data.

26. A motion information decoding apparatus comprising:
an indicator analyzing unit analyzing an indicator included in a bitstream of a second layer and determining a decoding rule corresponding to an encoding rule corresponding to the analyzed indicator, the bitstream of the second layer and a bitstream of a first layer being separated from a scalable bitstream; and
a motion compensation mode decoding unit decoding a motion compensation mode of the second layer based on the decoding rule determined by the indicator analyzing unit.

27. A motion information decoding apparatus comprising:
an indicator analyzing unit analyzing an indicator included in a bitstream of a second layer including enhancement motion data of a first layer and determining a decoding rule corresponding to an encoding rule corresponding to the analyzed indicator, a bitstream of the first layer with base motion data being separated from a scalable bitstream; and
a motion compensation mode decoding unit decoding a motion compensation mode of the enhancement motion data based on the decoding rule determined by the indicator analyzing unit.

28. A scalable video decoding method comprising:
separating a scalable bitstream into a bitstream for each layer by demultiplexing the scalable bitstream;
decoding a separated bitstream for a first layer by primarily referring to base motion data and secondarily referring to base motion data and enhancement motion data;
decoding a separated bitstream for a second layer by referring to video decoded from the bitstream of the first layer and motion data.

29. A motion information decoding method comprising:
analyzing an indicator included in a bitstream of a second layer and determining a decoding rule corresponding to an encoding rule corresponding to the analyzed indicator, the bitstream of the second layer and a bitstream of a first layer being separated from a scalable bitstream; and
decoding a motion compensation mode of the second layer based on the determined decoding rule.

30. A motion information decoding method comprising:
analyzing an indicator included in a bitstream of a second layer including enhancement motion data of a first layer and determining a decoding rule corresponding to an encoding rule corresponding to the analyzed indicator, a bitstream of the first layer with base motion data being separated from a scalable bitstream; and
decoding a motion compensation mode of the enhancement motion data based on the determined decoding rule.

31. A motion information encoding apparatus comprising:
an encoding rule determining unit assigning a single mode to a motion compensation mode of a second block, if motion compensation modes of a first block and the second block corresponding to the first block in motion data of a first layer and motion data of a second layer in a scalable bitstream generated by scalable video encoding are identical with each other; and
a motion compensation mode encoding unit transmitting the single mode as the motion compensation mode of the second block, if the motion compensation modes of a first block and the second block are identical with each other.
